(19) United States
(12) Patent Application Publication
(10) Pub. No.: US 2022/0410271 A1
(43) Pub. Date: Dec. 29, 2022

(54) METHOD FOR THE ADDITIVE MANUFACTURE OF COMPONENTS, DEVICE, CONTROL METHOD, AND STORAGE MEDIUM

(71) Applicants: Siemens Energy Global GmbH & Co. KG, München (DE); EOS GmbH Electro Optical Systems, Krailling (DE)

(72) Inventors: Matthias GOLDAMMER, München (DE); Henning HANEBUTH, Pliening OT Gelting (DE); Johannes CASPER, München (DE); Herbert HANRIEDER, Hohenkammer (DE); Martin LEUTERER, Olching (DE); Sebastian EDELHÄUSER, Zorneding (DE)

(21) Appl. No.: 17/638,682

(22) PCT Filed: Aug. 6, 2020
(86) PCT No.: PCT/EP2020/072193

§ 371 Date: Feb. 25, 2022

(30) Foreign Application Priority Data
Aug. 27, 2019 (DE) 10 2019 122 983.9

(51) Int. Cl. B22F 10/36; B22F 10/22; B22F 12/41; B22F 12/00; B22F 12/30; B22F 10/85; B22F 10/28; B33Y 10/00; B33Y 30/00; B33Y 50/02

(52) U.S. Cl. CPC B22F 10/36; B22F 10/22; B22F 12/41; B22F 12/22; B22F 12/30; B22F 10/85; B22F 10/28; B33Y 10/00; B33Y 30/00; B33Y 50/02

(57) ABSTRACT

The present invention relates to a method for the additive manufacture of components (2), wherein a pulverulent or wire-shaped metal construction material is deposited on a platform (4) in layers, melted using a primary heating device (7), in particular using a laser or electron beam (14), and is heated using an induction heating device (8), which has an alternating voltage supply device (9) with an induction generator (16) and at least one induction coil (10) which can be moved above the platform (4). The induction generator (16) is controlled such that the induction generator is driven with a different output at different specified positions of the at least one induction coil (10). The invention additionally relates to a device, to a control method, and to a storage medium.

The invention relates to a method for the additive manufacture of components, wherein a pulverulent or wire-shaped metal construction material is deposited on a platform in layers, melted using a primary heating device, in particular using a laser or electron beam, and is heated using an induction heating device which has an alternating voltage supply device with an induction generator and at least one induction coil that can be moved above the platform. In addition, the invention relates to a device, a control method, and a storage medium.

Processes for the additive manufacture of components are known in the prior art, such as selective laser melting (SLM, Selective Laser Melting) or plasma powder cladding (PTA, Plasma Transferred Arc), to name just a few examples.

In the additive manufacture of components from a pulverulent metal construction material, it is common for the pulverulent metal construction material to be applied in layers to a platform and, after each layer application, to be locally melted or sintered using a primary heating device, for example by means of a laser beam in the case of selective laser melting, in a processing area that is often also referred to as the build-up and joining zone, in order to gradually build up the component. For example, a CO2 laser, an Nd:Yag laser, a Yb fiber laser or a diode laser can be used as the laser source.

In contrast, in the case of plasma powder buildup welding, for example, a pulverulent metal construction material is injected into a plasma jet and melted by it before and/or while it is applied to a platform. The principle of melting before deposition is often also used in the manufacture of components from a wire-shaped metal construction material.

It is also known that a metal construction material can be heated before, during and/or after its melting using an induction heating device. By inductively heating the metal construction material before it is melted, i.e. preheating, hot cracking can be avoided, for example. Simultaneous heating of the metal construction material by the primary heating device and the induction heating device offers the advantage of increased heating output. Induction heating after melting allows the cooling of the metal construction material and/or component to be controlled. This can prevent the metallurgical properties of the component from deteriorating as a result of cooling too quickly. Overall, the use of an induction heating device in addition to the primary heating device enables better control of the heating and cooling of the metal material and leads to an improvement in the material properties.

The basic principle of induction heating devices is based on the fact that an induction coil is supplied with a high-frequency alternating voltage by an induction generator of an alternating voltage supply device, whereupon an alternating magnetic field is built up in the induction coil through which a corresponding high-frequency alternating current flows. This in turn causes eddy currents to be induced in a metal located in the vicinity of the induction coil, causing the metal to heat up. Thus, induction heating devices act only locally, limited to an area around the conductor of the induction coil, requiring mechanical movement of the induction coil to the particular location to be heated.

For this reason, the induction coils are usually arranged to move above the platform via a traversing unit. However, each positioning of the induction coil at a new position above the platform results in a change in physical variables of a device used to carry out the process for the additive manufacture of components, which in turn leads to the fact that the maximum output of the induction generator that can be retrieved also changes with each new position.

It applies to induction generators that they must not be set to an output at which they would be operated outside a permissible frequency range. In particular, an induction generator must not be set above a design inherent maximum output, otherwise damage to the induction generator would occur.

However, the maximum output of the induction generator that can be retrieved is not constant. If the traversing unit of the device used comprises at least one guide along which the induction coil can be moved back and forth in at least one direction and via which the induction coil is supplied with electrical energy from the induction generator, in the case of an electrical connection of the induction coil to the guide, which can be implemented in particular via sliding contacts, there is an extension or shortening of the electrical line length between the induction coil and the induction generator each time the induction coil is repositioned. This in turn affects the total ohmic resistance and thus the maximum output that can be retrieved at the respective position.

However, even if the induction coil is repositioned at the same position above the platform, there may be a change in physical quantities of the device compared to the previous positioning and thus a change in the retrievable maximum output of the induction generator. In the case of sliding contacts, for example, this can be due to the fact that the sliding contacts are in contact with the guide to a different extent after each positioning that has taken place, which affects the total ohmic resistance and thus the maximum output that can be called up.

In addition, the impedance consisting of inductance of the induction coil and ohmic losses, and thus the retrievable maximum output, may change due to self-excitation of eddy currents induced by the induction coil in a component with the induction coil.

Induction generators are known which monitor the relevant physical quantities and react, for example, to an imminent exceeding of the maximum output of the induction generator by switching off at an early stage. In this way, damage to the induction generator due to a possible overload is prevented. However, countermeasures to prevent shutdown cannot be initiated. Thus, reliable operation of a device comprising such an induction generator is not possible.

In addition, there are methods in which the induction generator is operated at a constant output which is far below the maximum output of the induction generator which can actually be retrieved. In this way, a forced shutdown of the induction generator is prevented, but at the same time the heating output is unnecessarily limited, which leads to an increase in the time required for heating the metallic material.

The invention is therefore based on the task of providing a method of the type mentioned at the outset which at least partially eliminates the disadvantages of the methods known from the prior art.

According to the invention, this task is solved in that the induction generator is controlled such that the induction generator is driven with a different output at different specified positions of the at least one induction coil.

The invention is thus based on the idea of operating the induction generator at different positions of the induction coil above a platform or above a construction field with different output and not, as in the previously known methods, with a constant output, in order to take into account the retrievable maximum output of the induction generator, which changes with the position of the induction coil. In this way, the induction generator can be operated at a higher output at a position of the induction coil at which a higher maximum output is retrievable compared to another position of the induction coil, which in turn increases the heating output of the induction coil and reduces the time required for heating the metallic material. The induction coil may be movable only in one plane, preferably in a plane parallel to the plane of the platform. However, it is also possible for the induction coil to be movable in a three-dimensional space. That is, the specified positions of the at least one induction coil may also have a different distance to the platform. The specified positions of the at least one induction coil may be set or become set with an accuracy of 1 mm. Preferably, the specified positions of the at least one induction coil are/is set to an accuracy of at most 100 μm, particularly preferably to an accuracy of at most 10 μm.

According to one embodiment of the invention, for each specified position of the at least one induction coil a maximum output of the induction generator that is retrievable at the respective specified position is determined and preferably stored in a storage device, in particular in a way that can be overwritten, and either directly following the determination of the retrievable maximum output or as soon as a specified position is again approached by the induction coil, the induction generator is controlled in such a way that it is operated with an output which is a predefined amount below the retrievable maximum output determined for the respective specified position. In particular, the determination of a retrievable maximum output for a specified position is performed at the specified position after it has been approached. The expression “directly following” means that even while the induction coil remains at a currently specified position for which an associated retrievable maximum output has just been determined in order to heat the metallic material, the output with which the induction generator is operated is set to a predefined amount below the retrievable maximum output just determined. In this way, the induction generator is prevented from shutting down due to exceeding a retrievable maximum output of the induction generator applicable at the particular specified position. In other words, a retrievable maximum output of the induction generator at a certain specified position can be determined in advance, so to speak, and suitable countermeasures, such as a down-regulation of the output of the induction generator, can be initiated in time before a critical limit of the induction generator is reached, so that the induction generator is always operated in a non-critical state. This enables reliable operation of a device for carrying out a process for the additive manufacture of components. In addition, the reliability of the device is improved. Since the retrievable maximum output of the induction generator is determined for each specified position of the induction coil and is thus known, the induction generator can be operated at each specified position with the highest possible output at this specified position and the induction coil can accordingly achieve the highest possible heating output at this specified position.

Preferably, the at least one induction coil is arranged to be movable above the platform via a traversing unit, and the traversing unit is electrically connected to the alternating voltage supply device via a supply line, the supply line comprising two electrical conductors in each of which a capacitor is arranged, so that the induction coil forms a resonant circuit with the capacitors. In this case, in the method for the additive manufacture of components, a retrievable maximum output of the induction generator for any specified position of the at least one induction coil can be determined by

a) the output of the induction generator is varied, preferably increased, within a predetermined output range between a lower output limit and an upper output limit, and measuring values of the output and measuring values of the frequency are detected during this process, the measuring values of the output being detected in particular indirectly by means of a detection of measuring values of the voltage and the current,

b) optionally, each output measuring value is stored with a frequency measuring value assigned to it,

c) a curve fitting of a predetermined frequency-dependent output model function to the detected output and frequency measuring values is carried out, wherein at least one value of the total ohmic resistance, which in particular comprises the ohmic resistances of the at least one induction coil, of the traversing unit and of the feed line and a value of the insulation resistance between the two electrical conductors of the feed line, in particular additionally a value of the inductance of the at least one induction coil are determined as free parameters of the output model function, whereby a resonance curve with a resonance peak is obtained; and

d) from the resonance curve, a value of the maximum output of the induction generator which can be retrieved at the respective specified position of the induction coil is determined.

In the method according to the invention, values of the total ohmic resistance and the insulation resistance at the respective specified positions can be determined, so to speak, by short scans over different outputs of the induction generator, which were previously inaccessible. Thus, the total ohmic resistance can be continuously monitored, for example, to detect creeping changes in the induction coil, the traversing unit and/or the feed line in good time and to take countermeasures if necessary. For example, maintenance of the device can be requested prior to a failure of the device.

In step a), the measured values of output, voltage, current and/or frequency may be obtained, for example, from a controller of the induction generator or by a separate measuring unit.

Furthermore, in step a), the output of the induction generator can be varied continuously and/or stepwise, preferably at predetermined, particularly preferably uniformly spaced points of time, from the lower output limit to the upper output limit. Here, the output is preferably increased from the lower output r limit to the upper output limit in the form of a ramp. Since current, voltage and frequency adjust relatively quickly (<100 ms) after positioning of the induction coil, ramp times in the range of seconds are sufficient. In particular, the output is increased from the output lower limit to the output upper limit in the form of a ramp with a ramp time in the range of 50 ms to 10 s, preferably in the range of 1 s to 2 s. Here, a ramp time in the range of 1-2 seconds represents the best compromise between the time spent and the quality of the data obtained. The ramp time can be 50 ms, 1 s, 2 s or 10 s. In particular, a “ramp” may be defined as the continuous change in output from a current value, such as the lower output limit, to a target value, such as the upper output limit, over a predetermined time. The predetermined time is referred to as the ramp time. In principle, however, it is also possible for different values of the output to be set in any order within the predetermined range.

In step b), the stored output measurement values can be plotted against the stored frequency measurement values.

Preferably, in step c) in the curve fitting the formula

$$P ( ω ) = \frac{{U}^{2}}{{Z}_{Total} ( ω )} or P ( ω ) = {I}^{2} \cdot {Z}_{Total} ( ω ) \\ where {Z}_{Total} ( ω ) = \frac{i}{{C}_{1} ω} - \frac{i}{{C}_{2} ω} + \frac{1}{\frac{1}{{R}_{ISO}} + \frac{1}{{R}_{Total} + iL ω}} \\ and nd ω = 2 πf$$

is used as the frequency-dependent output model function, where U is the voltage measured in particular at the output of the alternating voltage supply device (9), I is the current measured in particular downstream of the output of the alternating voltage supply device (9), preferably in the feed line (18), preferably between one of the capacitors (21, 22) and the alternating voltage supply device (9), Z_{Total}(ω) is the total impedance of the arrangement of at least the induction coil (10), the traversing unit (11), the supply line (18) and the capacitors (21, 22), R_{Total} is the total ohmic resistance, R_{ISO} is the insulation resistance, L is the inductance of the induction coil (10), C₁ and C₂ are the capacitances of the capacitors (21, 22), and wherein U and I are assumed to be constant.

Preferably, in step c) typical value ranges for the free parameters or a prefabricated curve similar to the resonance curve to be determined are taken into account in the curve fitting in order to reduce the time and resources required for the curve fitting. The typical value ranges and/or the prefabricated curve may be stored in a look-up table.

The value of the inductance of the induction coil can be assumed to be constant, since the change in inductance is relatively small compared to the change in total ohmic resistance when the induction coil is repositioned. However, it is also possible to include the value of the inductance as a free parameter.

In principle, the resonance curve obtained in step c) can be used to obtain in particular the resonance frequency, the retrievable maximum output and the total ohmic resistance (from the width of the resonance peak), from which the inductance of the induction coil can be calculated.

The resonance curve obtained in step c) can be plotted on a curve diagram, in particular superimposed on the output and frequency measurements plotted against each other.

Preferably, in step d) the retrievable maximum output P_{MAX} is determined from the resonance curve P_{Resonance}(ω) by algebraically and/or numerically determining the height of the resonance peak as the maximum of the resonance curve P_{Resonance}(ω). For example, the resonance curve P_{Resonance}(ω) can be derived according to ω and the derivative can be set equal to zero in order to determine the resonance frequency or the associated angular frequency ω_{Res}. by solving the resulting equation for ω. By inserting ω_{Res} in P_{Resonance}(ω), P_{Max} can be determined via P_{MAX}=P_{Resonance}(ω_{Res})

A further embodiment of the invention is characterized in that, using the retrievable maximum output determined in step d) and/or using a determined impedance, in particular total impedance Z_{Total}, preferably total impedance at the resonance frequency, or impedance of the induction coil, an active and/or reactive output prevailing at the respective specified position of the induction coil is determined.

Specifically, the determined impedance can enable multiple evaluations:
By determining the active and/or reactive output using the determined impedance, the heating output available at the component can be determined,
Since the ohmic resistance of the arrangement consisting of the induction coil and a traversing unit arrangement, which comprises at least the traversing unit, optionally additionally a feed line, via which the traversing unit is electrically connected to the alternating voltage supply device, depends on the one hand on the actual heating output into the component, but also on the losses in the traversing unit arrangement, it is possible to conclude the current state of the traversing unit arrangement in the case of a known component, for example on the contact resistance in the case of sliding contacts.

Furthermore, the output loss in the induction coil and the traversing unit arrangement can be calculated directly from the ohmic resistance, in particular the total ohmic resistance, allowing the available output in the electromagnetic field to be calculated.

Advantageously, the retrievable maximum output of the induction generator, in particular additionally the resonance curve, is stored with a specified position of the induction coil assigned to it.

According to an advantageous embodiment
a specified position is approached by the induction coil and, at the specified position, the output of the induction generator is increased from the lower output limit to a general upper output limit for which it is known that the induction generator can be reliably operated at any predeterminable position of the induction coil, and the maximum output of the induction generator which can be retrieved at the specified position is determined and preferably stored with the specified position of the induction coil assigned to it, and
after a renewed approach to the specified position, the output of the induction generator is increased from the lower output limit to the maximum output of the induction generator which can be retrieved during the previous approach to the specified position, and a new maximum output of the induction generator which can be retrieved is determined for the specified position and is preferably stored with the specified position of the induction coil assigned to it, in particular the maximum output which can be retrieved and which was previously stored for the specified position being overwritten with the new maximum output.

According to the invention, the aforementioned task is also solved by a device for the additive manufacture of components, having a platform which is provided in order to apply a pulverulent or wire-shaped metal material thereon in layers, a primary heating device, in particular a laser beam source or electron beam source, which is designed in order to melt a pulverulent or wire-shaped metal construction material preferably applied to the platform, an induction heating device, which has an alternating voltage supply device with an induction generator and at least one induction coil which can be moved above the platform and is designed to heat a pulverulent or wire-shaped metal construction material preferably applied to the platform, and a controller. The controller is designed and/or set up to control the induction generator in such a way that it is operated at different specified positions of the at least one induction coil with a different output.

According to one embodiment of the invention, the device comprises a processing device configured to determine, for each specified position of the induction coil, a maximum output of the induction generator retrievable at the respective specified position. Preferably, the storage device is designed to store the determined retrievable maximum outputs, in particular in a way that can be overwritten. The controller can be designed and/or set up to control the induction generator either directly after the determination of the retrievable maximum output or as soon as a specified position is again approached by the induction coil in such a way that the induction generator is operated with an output that is a predefined amount below the retrievable maximum output determined for the respective specified position.

The at least one induction coil can be arranged to be movable above the platform via a traversing unit. The traversing unit may be electrically connected to the alternating voltage supply device via a feed line. The feed line may comprise two electrical conductors, in each of which at least one capacitor is arranged so that the induction coil forms a resonant circuit with the capacitors.

A control and processing unit comprising the controller and the processing device may be configured and/or arranged to determine a retrievable maximum output of the induction generator for any specified position of the at least one induction coil by the controller being configured and/or arranged to vary, preferably increase, the output of the induction generator within a predetermined output range between a lower output limit and an upper output limit. The device may comprise a measuring unit comprising an ammeter and a voltmeter. The ammeter is advantageously located between a capacitor of the oscillating circuit and the alternating voltage supply device. The voltmeter is advantageously located between the two electrical conductors in an area between the capacitors of the oscillating circuit and the alternating voltage supply device. The measuring unit is preferably designed to acquire measured values of the output and measured values of the frequency during the variation of the output of the induction generator, in particular to acquire measured values of the output indirectly via an acquisition of measured values of the voltage and the current. The processing device is preferably designed and/or set up to perform a curve fitting of a predetermined frequency-dependent output model function to the acquired measured values of output and frequency and, in doing so, to determine at least one value of the total ohmic resistance and one value of the insulation resistance between the two electrical conductors of the feed line, in particular additionally a value of the inductance of the at least one induction coil as free parameters of the output model function and thus to obtain a resonance curve with a resonance peak. Furthermore, the processing device can be designed and/or set up to determine from the resonance curve a value of the maximum output of the induction generator that can be called up at the respective specified position of the induction coil.

The control system can be designed and/or set up to vary the output of the induction generator continuously and/or stepwise, preferably at predetermined, particularly preferably uniformly spaced points in time, from the lower output limit to the upper output limit.

To avoid repetition, reference is made to the above description of the method according to the invention with respect to further optional features. The device in general and its individual device components, such as the controller or the processing device, in particular, may be formed and/or arranged to perform any of the process steps previously mentioned in connection with the description of the process according to the invention.

Furthermore, the invention relates to a control method for controlling a device according to the invention, wherein the device according to the invention is controlled to perform a method according to the invention.

Furthermore, the invention relates to a storage medium comprising a program code which, when executed by a computing device, is designed and/or arranged to control an device according to the invention in such a way that the device carries out a method according to the invention.

Further, particularly advantageous embodiments and further embodiments of the invention result from the dependent claims as well as the above description, wherein the independent claims of one claim category can also be further developed analogously to the dependent claims and embodiments of another claim category and, in particular, individual features of different embodiments or variants can also be combined to form new embodiments or variants.

Further features and advantages of the present invention will become clear from the following description of an embodiment of a process for the additive manufacture of components according to an embodiment of the present invention, with reference to the accompanying drawing. Therein is

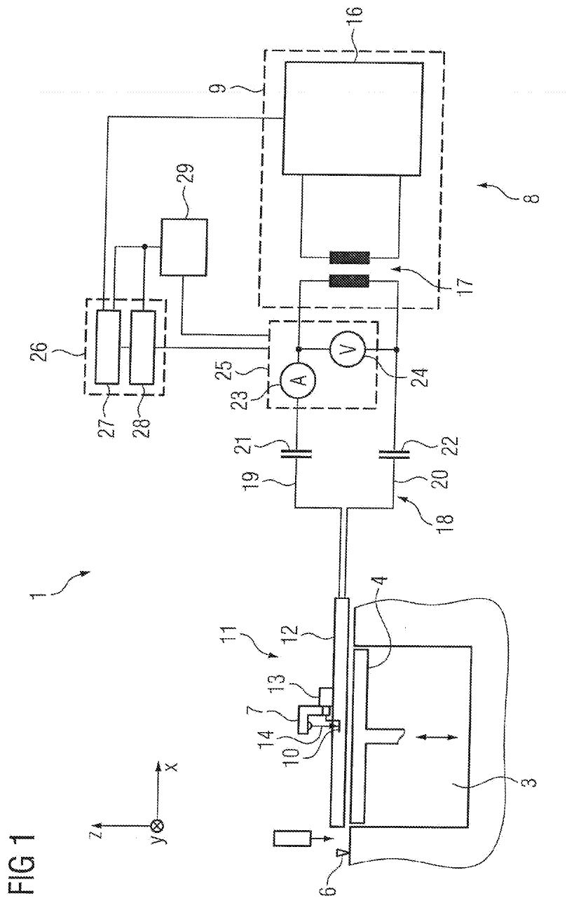

FIG. 1 a schematic side view of a device for carrying out a process for the additive manufacture of components according to an embodiment of the present invention,

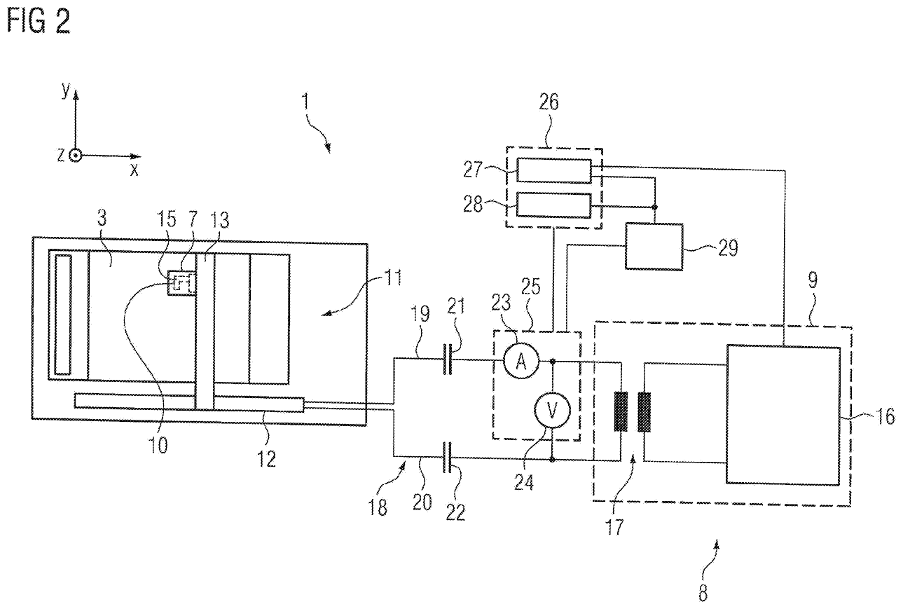

FIG. 2 a schematic top view of the device of FIG. 1,

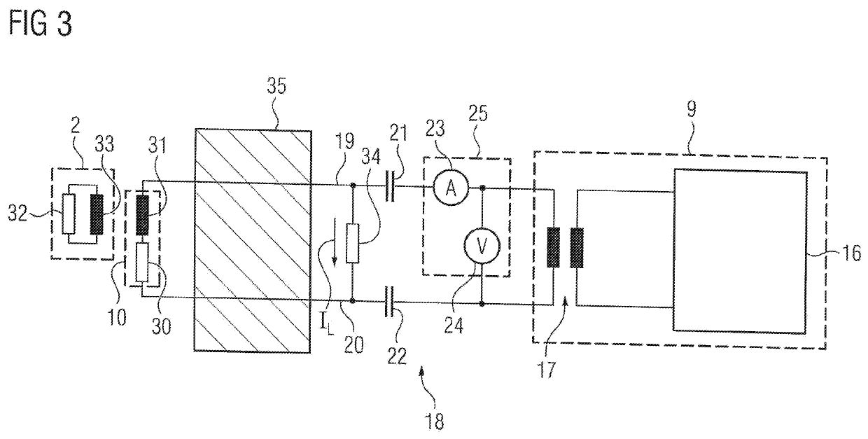

FIG. 3 a circuit diagram of the resonant outer circuit of the device with resistances and inductances drawn in,

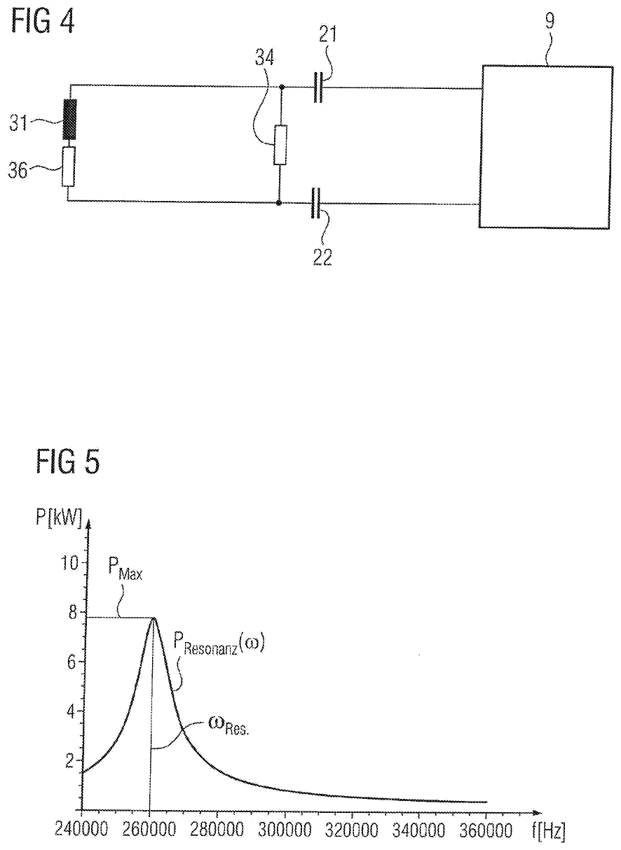

FIG. 4 a simplified version of the circuit diagram of FIG. 3, and

FIG. 5 a curve diagram with a resonance curve at a position of the induction coil.

In the following, the same reference numbers refer to similar components or sections of components.

A process according to one embodiment of the present invention is explained below with reference to an exemplary device 1 shown in FIGS. 1 to 3 for the additive manufacture of components 2 from a pulverulent metal construction material.

The device 1 comprises a powder bed space 3 in which a platform 4 is arranged, which extends within a plane spanned by the X-direction and the Y-direction and can be moved up and down in a Z-direction within the powder bed space 3. A powder supply device of the device 1, which is adapted to supply powder to the powder bed space 3 and to apply the supplied powder in a uniform powder layer, is formed in the present case by a powder delivery device 5 and a coating knife 6, which can be moved back and forth in the X-direction over the entire platform 4.

The device 1 further comprises a primary heating device, in this case a laser beam source 7, which can be a CO2 laser, an Nd:Yag laser, a Yb fiber laser or a diode laser. Furthermore, an induction heating device 8 is provided, which in the present case comprises an alternating voltage supply device 9 and an induction coil 10. The induction coil 10 and the laser beam source 7 are arranged to be movable together above the platform 4. For this purpose, a traversing unit 11 having a first guide 12 and a second guide 13 is provided, wherein the induction coil 10 and the laser beam source 7 are movable back and forth together in the X direction along the first guide 12 and in the Y direction along the second guide 13. The induction coil 10 and the laser beam source 7 are arranged relative to each other such that, during operation of the device 1, a laser beam 14 emerging from the laser beam source 7 can pass through a central opening 15 of the induction coil 10.

The alternating voltage supply device 9 comprises an induction generator 16 and a transformer 17. In the present case, the distance between the transformer 17 and the induction coil 10 is smaller than the distance between the induction generator 16 and the transformer 17. For reasons of space, this relationship cannot be taken from the figures. The transformer 17 thus serves to bring the output of the induction generator 16 to the induction coil 10 with as little loss as possible. The alternating voltage supply device 9 is electrically connected to the traversing unit 11 via a supply line 18. The traversing unit 11 is arranged to transmit the electrical energy supplied via the supply line 18 to the induction coil 10. For this purpose, the guides 12, 13 of the traversing unit 11 themselves serve as electrical conductors or electrical conductors are provided on the guides 12, 13. Similar electrical conductors of different guides 12, 13 are here electrically connected to each other via sliding contacts. For the sake of clarity, neither the electrical conductors of the guides 12, 13 nor the sliding contacts are shown in the figures. The feed line 18 comprises two electrical conductors 19, 20. A capacitor 21 is arranged in the electrical conductor 19 and a capacitor 22 is arranged in the electrical conductor 20. An ammeter 23 for measuring a current is located between the capacitor 21 and the alternating voltage supply device 9. In addition, a voltmeter 24 for tapping a voltage is disposed between the two electrical conductors 19, 20 in an area between the capacitors 21, 22 and the alternating voltage supply device not shown here, the voltmeter 24 and the ammeter 23 may alternatively be located between the transformer 17 and the induction generator 16.

The induction coil 10, the electrical conductors of the traversing unit 11, the supply line 18 with the capacitors 21, 22 and the alternating voltage supply device 9 form a so-called resonant outer circuit. More specifically, the capacitors 21, 22 and the induction coil 10 form a series resonant circuit.

Furthermore, the device 1 is provided with a control and processing unit 26 comprising a controller 27 and a processing device 28, and a storage device 29. The measuring unit 25 is connected to both the processing device 28 and the storage device 29. The storage device 29 is connected to both the controller 27 and the processing device 28. Further, the processing device 28 is connected to the controller 27. In addition, the controller 27 is arranged to control the movements of the platform 4, the powder delivery device 5, the coating knife 6 and the traversing unit 11. Corresponding connecting lines are omitted in the figures for clarity.

FIG. 3 shows an equivalent circuit diagram of the resonant outer circuit of the device 1. In contrast to FIGS. 1 and 2, the control and processing unit 26 and the storage device 29 in particular are not shown. The induction coil 10 is represented by its ohmic resistance 30 and its inductance 31. The component 2 is indicated by a dashed box and has an ohmic resistance 32. The fact that the eddy currents induced in the component 2 by the induction coil 10 and causing the desired heating of the component 2 are in self-excitation with the inductance 31 of the induction coil 10 is taken into account by the element 33 connected in parallel with the ohmic resistance 32 of the component 2. In parallel with the transformer 17, an insulation resistor 34 is drawn between the electrical conductors 19, 20 of the feed line 18, across which a leakage current I_{L} flows. In addition, between the induction coil 10 and the insulation resistor 34 is a hatched box 35, which is intended to indicate the variable ohmic resistance when the induction coil 10 is repositioned and/or when the sliding contacts of the traversing unit 11 are in contact with different strengths.

FIG. 4 shows the equivalent circuit of FIG. 3 in simplified form. Instead of element 30, which represents the ohmic resistance of the coil, element 36 is used, which represents the total ohmic resistance R_{Total} (including eddy currents in the component). The following relationship holds for the total impedance Z_{Total}(ω) of the arrangement consisting of the induction coil 10, the traversing unit 11, the feed line 18 and the capacitors 21, 22:

$${Z}_{G e s a m t} ( ω ) = \frac{i}{{C}_{1} ω} - \frac{i}{{C}_{2} ω} + \frac{1}{\frac{1}{{R}_{ISO}} + \frac{1}{{R}_{T o t a l} + iL ω}}$$

where ω=2πf and where C₁ represents the capacitance of capacitor 21, C₂ represents the capacitance of capacitor 22, R_{ISO} represents the insulation resistance 34, L represents the inductance of the coil, R_{Total} represents the total ohmic resistance represented by element 36, which includes the ohmic resistances of inductor 10, traversing unit 11, and feed line 18, ω represents the angular frequency, and f represents the frequency.

For the frequency-dependent output model function, the formula is:

$$P ( ω ) = \frac{{U}^{2}}{{Z}_{T o t a l} ( ω )} or P ( ω ) = {I}^{2} \cdot {Z}_{T o t a l} ( ω )$$

where U represents the voltage measured by means of the voltmeter 24 and I represents the current measured by means of the ammeter 23. In the present case, U and I are assumed to be constant.

To generate a component 2, a first powder bed, i.e. a first powder layer of a pulverulent metal material, of uniform thickness is applied to the platform 4 using the powder delivery device 5 and the coating knife 6 in a first step. In a next step, the arrangement consisting of the laser beam source 7 and the induction coil 10 is moved to a first specified position by means of the traversing unit 11 and controlled by the controller 27. The laser beam 14 generated by the laser beam source 7 is now directed through the opening 15 of the induction coil 10 onto a point of the surface of the powder bed to be processed and melts it. Subsequently, the melted powder material is heated by means of the induction heating device 8, whereby no or at least no substantial heating of the unprocessed powder material takes place. For this purpose, the output of the induction generator 16 is first increased in the form of a ramp from a lower output limit of presently about 0.5 kW to a general upper output limit of presently about 6.25 kW, for which it is known that the induction generator 16 can be reliably operated at any predeterminable position of the induction coil 10. As the output is increased, the induction generator 16 continuously shifts the frequency f toward the resonant frequency f_{Res}. (ω_{Res}=2πf_{Res}). Here, measuring values of output P and measuring values of frequency f are determined by means of the measuring unit 25. Each output measuring value is stored with an associated frequency measuring value in the storage device 29. The measuring values of the retrieved output are plotted against the measuring values of the frequency in a curve diagram by means of the processing device 28, see FIG. 5.

In a next step, a curve fitting of the above described frequency-dependent output model function P(ω) to the acquired output and frequency measuring values is performed by means of the processing device 28. Here, the value L of the inductance 31 is assumed to be constant for simplification. The value R_{Total} of the total ohmic resistance 36 and the value R_{ISO} of the insulation resistance 34 are determined as free parameters of the output model function P(ω) during curve fitting. By inserting the determined free parameters into the output model function P(ω), a function for a resonance curve P_{Resonance}(ω) is obtained. The resonance curve P_{Resonance}(ω) is superimposed on the measuring points of the curve diagram, see FIG. 5. A so-called resonance peak is clearly visible. From the resonance curve P_{Resonance}(ω), the value of the maximum output P_{Max} of the induction generator 16 that can be retrieved at the first specified position of the induction coil 10 is now determined as the height of the resonance peak. More precisely, the height of the resonance peak is determined as the maximum of the resonance curve P_{Resonance}(ω) by solving P_{Resonance}(ω) for ω, setting the derivative equal to zero and solving the resulting equation for ω, yielding ω_{Res}. which is presently about 260000 Hz. inserting ω_{Res}. into P_{Resonance}(ω) yields a value for the maximum output P_{Max} that can be retrieved at the first specified position, which in the present case is about 7.75 kW. P_{Max} is stored in the storage device together with the first specified position.

In a next step, the arrangement consisting of the laser beam source 7 and the induction coil 10 is moved to a second specified position by means of the traversing unit 11 and controlled by the control 27. Here, melting of a further area of the surface of the powder bed to be processed takes place by means of the laser beam 14 of the laser beam source 7. Subsequently, the melted powder material is heated by means of the induction heating device 8. Here again, a measuring value determination and processing of the measuring values take place as already described in detail before in connection with the first position. In this way, the arrangement consisting of the laser beam source 7 and the induction coil 10 is moved from position to position by means of the traversing unit 11 in order to selectively melt the powder of the first powder layer according to a desired component structure.

Subsequently, the platform 4 is lowered in the Z-direction by the amount of a powder layer thickness. Using the powder delivery device 5 and the coating knife 6, a second powder bed, i.e. a second powder layer of the pulverulent metal construction material, of uniform thickness is now applied to the platform 4.

The arrangement consisting of the laser beam source 7 and the induction coil 10 is moved a second time to the first specified position by means of the traversing unit 11 and controlled by the control 27. First of all, a spot of the surface of the second powder layer to be processed is melted by means of the laser beam 14 of the laser beam source 7. Subsequently, the melted powder material is heated by means of the induction heating device 8. For this purpose, the output of the induction generator 16 is increased in the form of a ramp from the lower output limit to the retrievable maximum output P_{Max} of the induction generator 16 determined during the last approach to the first position. Again, a measuring value determination and processing of the measuring values take place as described in detail before. In particular, a new retrievable maximum output P_{Max} of the induction generator 16 for the first position is determined and stored with the first position of the induction coil 10 in the storage device 29. The previously stored retrievable maximum output is overwritten with the newly determined retrievable maximum output. This process is continued until the component 2 is fully generated.

In summary, the induction generator 16 is controlled by means of the controller 27 in such a way that it is operated at different specified positions of the induction coil 10 during the generation of the component 2 with different outputs. More specifically, at each specified position approached by the induction coil 10, the maximum output of the induction generator 16 that can be retrieved at that position is determined and stored in the storage device 29. As soon as this specified position is again approached by the induction coil 10, the induction generator 16 is controlled by means of the controller 27 in such a way that it is operated with an output which is a predefined amount below the retrievable maximum output determined for this specified position.

Although the invention has been further illustrated and described in detail by the preferred example embodiment, the invention is not limited by the disclosed examples and other variations may be derived therefrom by those skilled in the art without departing from the scope of protection of the invention.

1. Method for the additive manufacture of components (2), wherein a pulverulent or wire-shaped metal construction material is deposited on a platform (4) in layers, melted using a primary heating device (7), in particular using a laser or electron beam (14), and is heated using an induction heating device (8), which has an alternating voltage supply device (9) with an induction generator (16) and at least one induction coil (10) which can be moved above the platform (4), wherein the induction generator (16) is controlled such that the induction generator (16) is driven with a different output at different specified positions of the at least one induction coil (10).

2. The method according to claim 1, wherein for each specified position of the at least one induction coil (10) a maximum output of the induction generator (16) that is retrievable at the respective specified position is determined and preferably stored in a storage device (29), in particular in a way that can be overwritten, and either directly following the determination of the retrievable maximum output or as soon as a specified position is again approached by the induction coil (10), the induction generator (16) is controlled in such a way that it is operated with an output which is a predefined amount below the retrievable maximum output determined for the respective specified position.

3. Method according to claim 2, wherein the at least one induction coil (10) is arranged to be movable above the platform (4) via a traversing unit (11), and the traversing unit (11) is electrically connected to the alternating voltage supply device (9) via a supply line (18), the supply line (18) comprising two electrical conductors (19, 20), in each of which at least one capacitor (21, 22) is arranged, so that the induction coil (10) forms an oscillating circuit with the capacitors (19, 20), and wherein a retrievable maximum output of the induction generator (16) is determined for any specified position of the at least one induction coil (10), in that
a) the output of the induction generator (16) is varied, preferably increased, within a predetermined output range between a lower output limit and an upper output limit, and measuring values of the output and measuring values of the frequency are detected during this process, the measuring values of the output being detected in particular indirectly by means of a detection of measuring values of the voltage and the current,
b) optionally, each output measuring value is stored with a frequency measuring value assigned to it,
c) a curve fitting of a predetermined frequency-dependent output model function to the detected output and frequency measuring values is carried out, wherein at least one value of the total ohmic resistance, which in particular comprises the ohmic resistances of the at least one induction coil (10), of the traversing unit (11) and of the feed line (18) and a value of the insulation resistance (34) between the two electrical conductors (19, 20) of the feed line (18), in particular additionally a value of the inductance of the at least one induction coil (10) are determined as free parameters of the output model function, whereby a resonance curve with a resonance peak is obtained; and
d) from the resonance curve, a value of the maximum output of the induction generator (16) which can be retrieved at the respective specified position of the induction coil (10) is determined.

4. Method according to claim 3, wherein the retrievable maximum output of the induction generator (16), in particular additionally the resonance curve, is stored with a specified position of the induction coil (10) assigned to it.

5. Method according to claim 3, wherein in step a) the output of the induction generator (16) is varied continuously and/or stepwise, preferably at predetermined, particularly preferably at uniformly spaced points in time, from the lower output limit to the upper output limit, the output preferably being increased from the lower output limit to the upper output limit in the form of a ramp, in particular with a ramp time in the range from 50 ms to 10 s, preferably in the range from 1 s to 2 s.

6. Method according to claim 4, wherein
a specified position is approached by the induction coil (10) and, at the specified position, the output of the induction generator (16) is increased from the lower output limit to a general upper output limit for which it is known that the induction generator (16) can be reliably operated at any predeterminable position of the induction coil (10), and the maximum output of the induction generator (16) which can be retrieved at the specified position is determined and preferably stored with the specified position of the induction coil (10) associated therewith, and
after a renewed approach to the specified position, the output of the induction generator (16) is increased from the lower output limit to the retrievable maximum output of the induction generator (16) determined during the previous approach to the specified position, and a new retrievable maximum output of the induction generator (16) is determined for the specified position and is preferably stored with the specified position of the induction coil (10) assigned to it, in particular the retrievable maximum output previously stored for the specified position being overwritten with the new retrievable maximum output.

7. Method according to 6 claim 3, wherein in step c) in the curve fitting the formula:
$$( ω ) = \frac{{U}^{2}}{{Z}_{T o t a l} ( ω )} or P ( ω ) = {I}^{2} \cdot {Z}_{Total} ( ω ) \\ where {Z}_{Total} ( ω ) = \frac{i}{{C}_{1} ω} - \frac{i}{{C}_{2} ω} + \frac{1}{\frac{1}{{R}_{ISO}} + \frac{1}{{R}_{T o t a l} + i L ω}} \\ and ω = 2 π f$$
is used as the frequency-dependent output model function, where U is the voltage measured in particular at the output of the alternating voltage supply device (9), I is the current measured in particular downstream of the output of the alternating voltage supply device (9), preferably in the feed line (18), preferably between one of the capacitors (21, 22) and the alternating voltage supply device (9), Z_{Total}(ω) is the total impedance of the arrangement of at least the induction coil (10), the traversing unit (11), the supply line (18) and the capacitors (21, 22), R_{Total} is the total ohmic resistance, R_{ISO} is the insulation resistance, L is the inductance of the induction coil (10), C1 and C2 are the capacitances of the capacitors (21, 22), and wherein U and I are assumed to be constant.

8. Method according to claim 3, wherein in step c) typical value ranges for the free parameters or a prefabricated curve similar to the resonance curve to be determined are taken into account in the curve fitting in order to reduce the time and resources required for the curve fitting, the typical value ranges and/or the prefabricated curve being stored in a look-up table.

9. Method according to claim 3, wherein in step d) the retrievable maximum output P_{MAX} is determined from the resonance curve P_{Resonance}(ω) by algebraically and/or numerically determining the height of the resonance peak as the maximum of the resonance curve P_{Resonance}(ω).

10. Method according to claim 3, wherein, using the retrievable maximum output determined in step d), an active and/or reactive output prevailing at the respective specified position of the induction coil (10) is determined, wherein, in step d), using the determined total impedance Z_{Total} at a resonance frequency, an active and/or reactive output prevailing at the respective specified position of the induction coil (10) is determined.

11. Device (1) for the additive manufacture of components (2), having a platform (4) which is provided in order to apply a pulverulent or wire-shaped metal construction material thereon in layers, a primary heating device (7), in particular a laser beam source (7) or electron beam source, which is designed in order to melt a pulverulent or wire-shaped metal construction material preferably applied to the platform (4), an induction heating device (8), which has an alternating voltage supply device (9) with an induction generator (16) and at least one induction coil (10) which can be moved above the platform (4) and is designed to heat a pulverulent or wire-shaped metal construction material preferably applied to the platform (4), and a controller (27), wherein the controller (27) is designed and/or set up to control the induction generator (16) in such a way that it is operated at different specified positions of the at least one induction coil (10) with a different output.

12. Control method for controlling a device (1) according to claim 11, wherein the device (1) is controlled to perform a method according to claim 1.

13. Storage medium comprising a program code which, when executed by a computing device, is designed and/or arranged to control a device according to claim 11 and to perform a method according to claim 1.

14. Method according to claim 4, wherein in step a) the output of the induction generator (16) is varied continuously and/or stepwise, preferably at predetermined, particularly preferably at uniformly spaced points in time, from the lower output limit to the upper output limit, the output preferably being increased from the lower output limit to the upper output limit in the form of a ramp, in particular with a ramp time in the range from 50 ms to 10 s, preferably in the range from 1 s to 2 s.

15. Method according to claim 5, wherein
a specified position is approached by the induction coil (10) and, at the specified position, the output of the induction generator (16) is increased from the lower output limit to a general upper output limit for which it is known that the induction generator (16) can be reliably operated at any predeterminable position of the induction coil (10), and the maximum output of the induction generator (16) which can be retrieved at the specified position is determined and preferably stored with the specified position of the induction coil (10) associated therewith, and
after a renewed approach to the specified position, the output of the induction generator (16) is increased from the lower output limit to the retrievable maximum output of the induction generator (16) determined during the previous approach to the specified position, and a new retrievable maximum output of the induction generator (16) is determined for the specified position and is preferably stored with the specified position of the induction coil (10) assigned to it, in particular the retrievable maximum output previously stored for the specified position being overwritten with the new retrievable maximum output.

16. Method according to claim 4, wherein in step c) in the curve fitting the formula:
$$( ω ) = \frac{{U}^{2}}{{Z}_{T o t a l} ( ω )} or P ( ω ) = {I}^{2} \cdot {Z}_{Total} ( ω ) \\ where {Z}_{Total} ( ω ) = \frac{i}{{C}_{1} ω} - \frac{i}{{C}_{2} ω} + \frac{1}{\frac{1}{{R}_{ISO}} + \frac{1}{{R}_{T o t a l} + i L ω}} \\ and ω = 2 πf$$
is used as the frequency-dependent output model function, where U is the voltage measured in particular at the output of the alternating voltage supply device (9), I is the current measured in particular downstream of the output of the alternating voltage supply device (9), preferably in the feed line (18), preferably between one of the capacitors (21, 22) and the alternating voltage supply device (9), Z_{Total}(ω) is the total impedance of the arrangement of at least the induction coil (10), the traversing unit (11), the supply line (18) and the capacitors (21, 22), R_{Total} is the total ohmic resistance, R_{ISO} is the insulation resistance, L is the inductance of the induction coil (10), C1 and C2 are the capacitances of the capacitors (21, 22), and wherein U and I are assumed to be constant.

17. Method according to claim 5, wherein in step c) in the curve fitting the formula:
$$( ω ) = \frac{{U}^{2}}{{Z}_{T o t a l} ( ω )} or P ( ω ) = {I}^{2} \cdot {Z}_{Total} ( ω ) \\ where {Z}_{Total} ( ω ) = \frac{i}{{C}_{1} ω} - \frac{i}{{C}_{2} ω} + \frac{1}{\frac{1}{{R}_{ISO}} + \frac{1}{{R}_{T o t a l} + i L ω}} \\ and ω = 2 πf$$
is used as the frequency-dependent output model function, where U is the voltage measured in particular at the output of the alternating voltage supply device (9), I is the current measured in particular downstream of the output of the alternating voltage supply device (9), preferably in the feed line (18), preferably between one of the capacitors (21, 22) and the alternating voltage supply device (9), Z_{Total}(ω) is the total impedance of the arrangement of at least the induction coil (10), the traversing unit (11), the supply line (18) and the capacitors (21, 22), R_{Total} is the total ohmic resistance, R_{ISO} is the insulation resistance, L is the inductance of the induction coil (10), C1 and C2 are the capacitances of the capacitors (21, 22), and wherein U and I are assumed to be constant.

18. Method according to claim 6, wherein in step c) in the curve fitting the formula:
$$( ω ) = \frac{{U}^{2}}{{Z}_{T o t a l} ( ω )} or P ( ω ) = {I}^{2} \cdot {Z}_{Total} ( ω ) \\ where {Z}_{Total} ( ω ) = \frac{i}{{C}_{1} ω} - \frac{i}{{C}_{2} ω} + \frac{1}{\frac{1}{{R}_{ISO}} + \frac{1}{{R}_{T o t a l} + i L ω}} \\ and ω = 2 πf$$
is used as the frequency-dependent output model function, where U is the voltage measured in particular at the output of the alternating voltage supply device (9), I is the current measured in particular downstream of the output of the alternating voltage supply device (9), preferably in the feed line (18), preferably between one of the capacitors (21, 22) and the alternating voltage supply device (9), Z_{Total}(ω) is the total impedance of the arrangement of at least the induction coil (10), the traversing unit (11), the supply line (18) and the capacitors (21, 22), R_{Total} is the total ohmic resistance, R_{ISO} is the insulation resistance, L is the inductance of the induction coil (10), C1 and C2 are the capacitances of the capacitors (21, 22), and wherein U and I are assumed to be constant.
